(19) United States
(12) Patent Application Publication
(10) Pub. No.: US 2023/0322036 A1
(43) Pub. Date: Oct. 12, 2023

(54) ACTIVE MECHANICAL SAFETY DEVICE FOR THE COMPENSATION OF THE IMPACTS ON A VEHICLE

(71) Applicant: NEWTRON GROUP SA, Lugano (CH)

(72) Inventor: Nicola VENUTO, Lugano (CH)

(73) Assignee: NEWTRON GROUP SA, Lugano (CH)

(21) Appl. No.: 18/042,017

(22) PCT Filed: Aug. 23, 2021
(86) PCT No.: PCT/IB2021/057704

§ 371 Date: Feb. 17, 2023

(30) Foreign Application Priority Data
Aug. 24, 2020 (IT) 102020000020374

(51) Int. Cl. B60G 15/04; B60G 17/02; B60G 99/00

(52) U.S. Cl. CPC B60G 15/04; B60G 17/021; B60G 99/006; B60G 2202/312; B60G 2300/02; B60G 2204/1242; B60G 2204/422; B60G 2204/47; B60G 2206/41; B60G 2202/43

(57) ABSTRACT

An active mechanical safety device for the compensation of the impacts on a vehicle, comprising a connecting element configured to be constrained to a suspended mass of a vehicle, a respective adjustment element configured to be constrained to the suspended mass and to be positioned between the connecting element and a respective shock absorber element of said vehicle, wherein the adjustment element, following an external stress to which the vehicle is subjected, is movable between a first position, wherein the adjustment element is configured to approach the connecting element to the shock absorber element, and a second position, wherein the adjustment element is configured to move the connecting element away from the shock absorber element.

### TECHNICAL FIELD

The present invention relates to an active mechanical safety device for the compensation of the impacts on a vehicle. In particular, the present invention is particularly used in both civil and sport vehicles, even more particularly in vehicles with a driver's cab positioned above the portion of the front chassis supporting the front wheels.

### BACKGROUND ART

As is well known, vehicles in general are provided with various active and passive safety systems.

An “active” safety device is generally defined as a protective system which reduces the possibility of an adverse event occurring. Active systems tend to be operated prior to the event, e.g., during braking (ABS), during motion to improve stability (EPS), etc.

On the other hand, a “passive” safety device is a protective device which comes into operation when a harmful event occurs, such as, e.g., airbags, seat belts, chassis, child seats, etc.

With particular reference to the different functions of the chassis, it is necessary to specify that, normally, besides acting as a support for the parts of the vehicle, it must be made according to very specific standards in order to be able to support the shocks following any accidents. The kinetic energy is usually transferred to the chassis and reset as a result of the deformation of the latter. It follows that in normal vehicles on the market today, most of the work done to absorb an impact is carried out by the chassis in combination, possibly, with the bodywork. It is well known that chassis have to pass several crash tests and are therefore designed with one or more programmed failure zones aimed at receiving a predefined amount of energy following an impact. However, it can happen that, following certain impacts, for example violent ones, the deformations in the programmed failure zones become plastic and therefore non-reversible. As a result, the chassis is unrecoverable or extremely advanced repairs are required.

### DESCRIPTION OF THE INVENTION

The Applicant has realized that by making a suitable linkage coupled to the chassis and to the suspensions of the vehicles, it is possible to greatly improve the protection of the occupants of a vehicle by increasing the attenuation conditions of the forces in play deriving from external stresses, such as those normally acting following an accident.

The Applicant has found that it is therefore possible to preemptively discharge the kinetic energy arising from frontal and/or side impacts before they reach the chassis onto the vehicles' suspensions, the latter being normally used with quite different objectives (such as, e.g., stability and/or comfort) than the safety purposes of the system of the present invention.

By virtue of the above requirements, one object of the present invention therefore relates to an active mechanical safety device for the compensation of the impacts on a vehicle according to claim 1.

Another object of the present invention relates to a vehicle provided with at least one suspension system positioned between the unsuspended masses and at least one suspended mass of the vehicle, and comprising at least one mechanical safety system according to claim 10.

### BRIEF DESCRIPTION OF THE DRAWINGS

Further characteristics and advantages of the active mechanical safety device for the compensation of the impacts on a vehicle and of the related vehicle according to the present invention will result from the description below of preferred examples thereof, given by way of an indicative yet non-limiting example, with reference to the attached figures, wherein:

FIG. 1 represents a schematic perspective view of a preferred embodiment of the active mechanical safety device for the compensation of the impacts on a vehicle according to the present invention,

FIG. 2 represents a perspective view of an adjustment element forming part of the device of FIG. 1,

FIGS. 3 and 4 represent perspective views of the adjustment element of FIG. 2 operating according to two operating conditions, in compression and stretching, respectively,

FIG. 5 represents a schematic perspective view of a further embodiment of the active mechanical safety device for the compensation of the impacts on a vehicle according to the present invention.

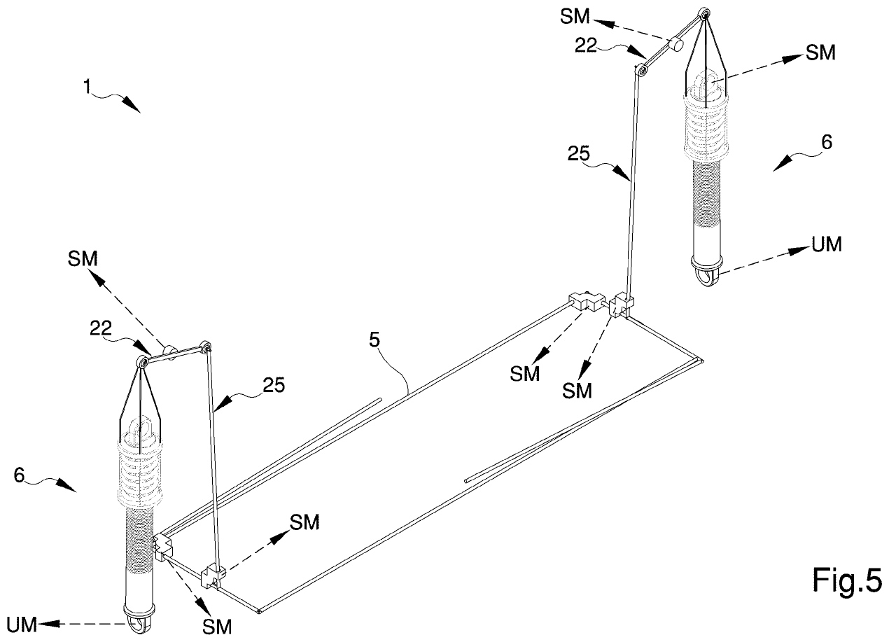

### EMBODIMENTS OF THE INVENTION

With reference to the attached figures, reference numeral 1 globally indicates an active mechanical safety device for the compensation of the impacts on a vehicle according to the present invention.

Such a device 1 may be used for vehicles for civil and/or sports use, but is particularly used also in vehicles not subject to crash tests, such as, e.g., vehicles belonging to category N with the driver's cab positioned above the portion of front chassis supporting the front wheels.

The device 1 is configured to constrain one or more unsuspended masses of the vehicle.

By “unsuspended mass” of a vehicle is meant all the components closely linked to a wheel. In particular, these elements are considered to be unsuspended as they do not vary in shape or distance from the wheel. The unsuspended masses may comprise, e.g., the wheel itself, the hub, the discs and calipers of the braking system, etc. The latter are connected to a suspended mass of the vehicle by means of the suspensions which undergoes continuous variations in terms of their distance from the suspended mass.

On the contrary, by “suspended mass” is meant all the components which undergo a variation in their distance from the ground sustained by the suspensions and which may comprise, in particular, the chassis, the engine, the bodywork, etc.

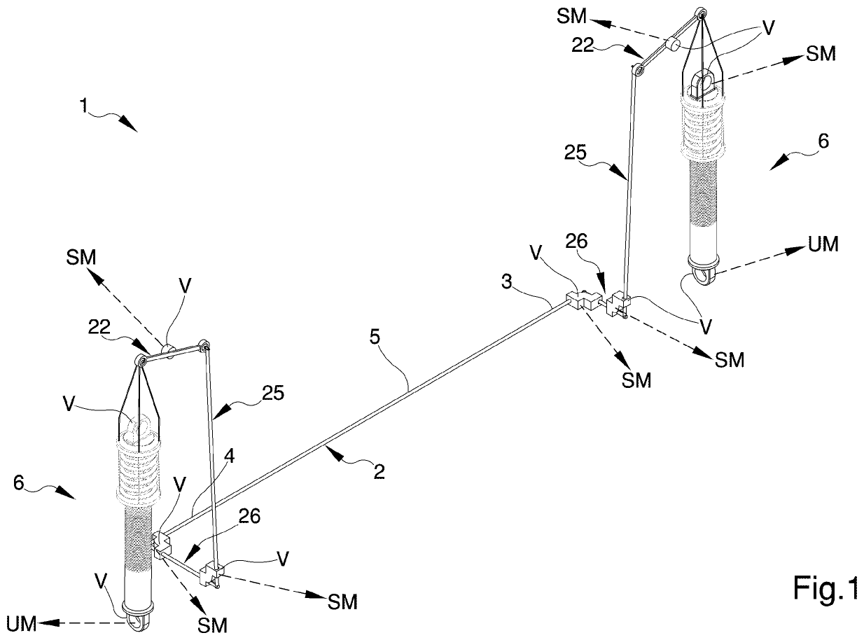

As shown in the example of FIG. 1, the device 1 comprises a connecting element 2 extending between two terminal portions 3, 4 and an intermediate portion 5 positioned between the terminal portions 3, 4. Conveniently, the connecting element 2 is configured to be constrained to a suspended mass SM of the vehicle.

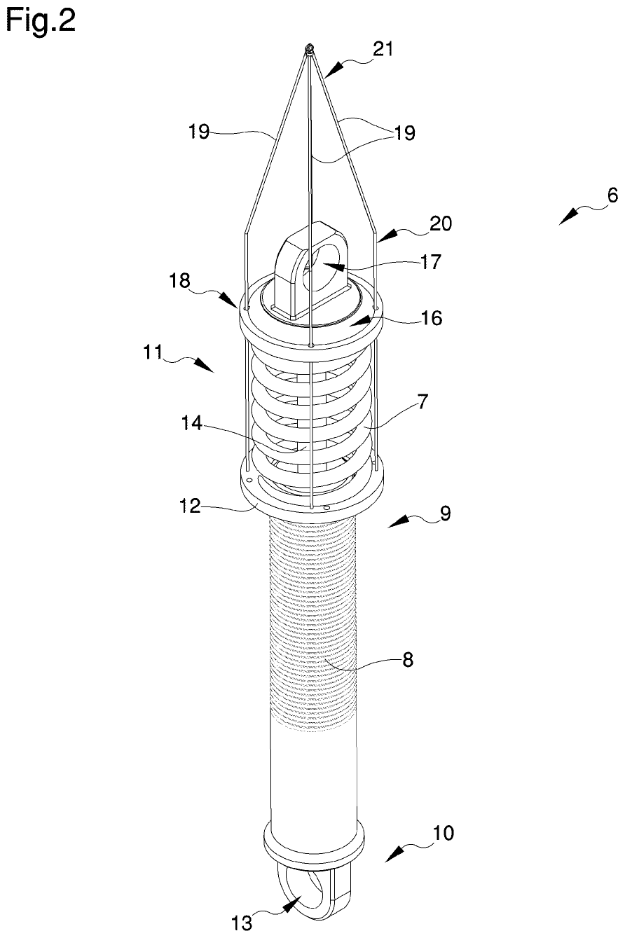

With reference to the example shown in FIGS. 1 and 2, the terminal portions 3, 4 of the connecting element 2 connect respective adjustment elements 6. In the remainder of the present disclosure, the indications referring to an adjustment element 6 are to be considered exhaustive also with reference to other possible adjustment elements provided in the device 1 of the invention, since the adjustment elements are entirely similar to each other.

Each adjustment element 6 is preferably part of a suspension system of the vehicle and comprises an elastic element 7, configured to vary the dimension thereof following an external stress to which the vehicle is subjected, positioned between a shock absorber element 8 and a piston 11. More in detail, the shock absorber element 8 extends along a prevailing direction of extension thereof between an upper end 9 and a lower end 10 and defines inside itself a housing compartment, preferably cylindrical, to house the piston 11. The piston 11 is configured to slide at least partly inside the housing compartment of the shock absorber element 8. The shock absorber element 8 also has an upper abutment portion 12 positioned at its upper end 9 and a lower seat 13 to connect the shock absorber element 8 to an unsuspended mass UM, in particular to a wheel of the vehicle by means, e.g., of a typical mechanical joint.

In detail, the piston 11 comprises a head (not shown) configured to slide along the direction of extension of the shock absorber element 8 inside the housing compartment according to techniques known in themselves. Furthermore, the piston 11 is provided with a stem 14 locked together to the head and extending along the direction of extension of the shock absorber element 8 between its own terminal ends wherein, at the upper terminal end, arranged outside the housing compartment, there is a plate 16 intended to be connected to a suspended mass SM of the vehicle by means of a respective upper seat 17.

As shown in the examples of the attached figures, the elastic element 7 is positioned between the upper abutment portion 12 of the shock absorber element 8 and the plate 16 of the piston 11 and preferably comprises a helical spring coaxial to the direction of extension of the shock absorber element 8 and has a preset elastic constant and a predetermined preload value.

Thanks to the configuration described above, following an external stress tending to load the suspended masses of the vehicle with consequent oscillation of the same around its own longitudinal axis (e.g. following a front, lateral or rear impact) each adjustment element 6 operates in reaction to this stress by moving between a first position, wherein it is configured to approach the connecting element 2 to the shock absorber element 8, and a second position, wherein it is configured to move the connecting element 2 away from the shock absorber element 8. By means of this configuration, it is therefore advantageously possible to filter part of the kinetic energy operating on the vehicle firstly on the adjustment elements 6 and, consequently, on the elastic elements 7, before this energy reaches the suspended masses (e.g. the chassis) of the vehicle.

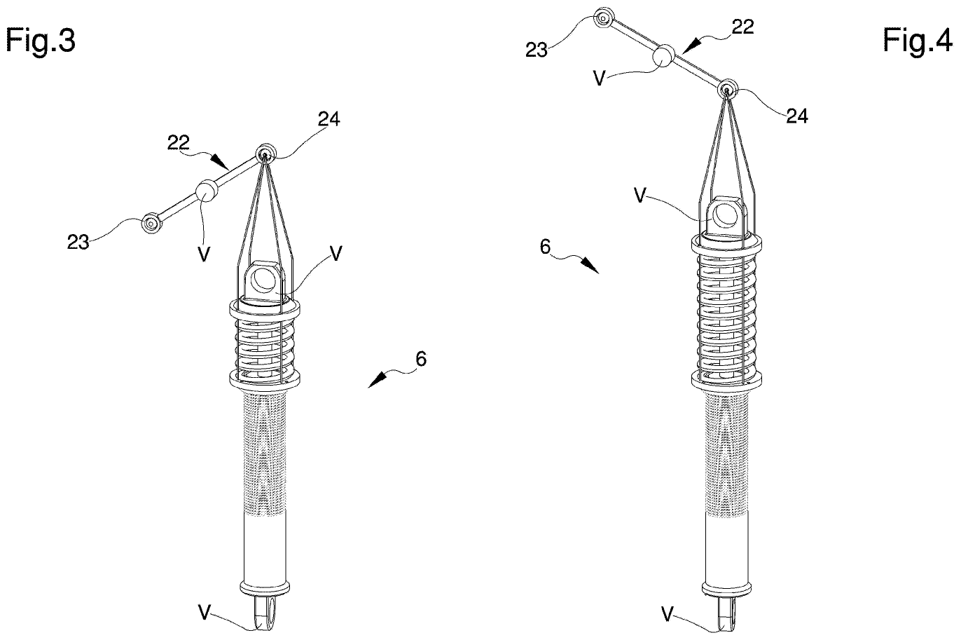

In actual facts, as shown in the example of FIG. 3, in the first position, the upper abutment portion 12 of the shock absorber element 8 is moved closer to the plate 16 of the piston 11 to allow a preload variation of the elastic element 7, the latter operating therefore in compression to offer resistance to stress. In the second position (FIG. 4), the upper abutment portion 12 of the shock absorber element 8 is moved away from the plate 16 of the piston 11 to allow a further preload variation of the elastic element 7, which therefore operates in a condition of stretching.

To this end, advantageously, the plate 16 of the piston 11 has at least one through hole 17 for the transit of a corresponding tie rod 19 extending between its own lower end portions 20 and upper end portions 21.

In one embodiment, the plate 16 of the piston 11 has a substantially cylindrical shape and is provided with a plurality of holes 18, preferably four in number, arranged in substantially circumferential positions. Preferably, the holes 18 are arranged two by two in diametrically opposite positions to receive a respective tie rod 19.

As observable, the lower end portion 20 of each tie rod 19 is connected to the upper abutment portion 12 of the shock absorber element 8.

In one embodiment, the tie rods 19 (in the illustrated examples four in number, one passing through each hole 18) are connected together at a common connection point at their upper end portions 21.

Conveniently, the connections between the different elements of the device 1 of the invention and the suspended masses SM and/or unsuspended masses UM are made at respective constraint points V as illustrated in the attached figures.

According to one embodiment, the device 1 of the invention comprises at least one crank 22 extended between a first termination 23 and a second termination 24 and configured to rotate around its own constraint point V positioned between the terminations 23, 24. The constraint point V of the crank is configured to be constrained to a suspended mass SM of the vehicle and arranged substantially midway between the terminations 23, 24.

The crank 22 is positioned between the connecting element 2 and the adjustment element 6, in particular the first termination 23 of the crank 22 is connected to the first terminal portion 3 of the connecting element and the second termination 24 is connected to the upper extremity of the tie rod 19, in particular at the common connection point of the tie rods 19.

According to further embodiments, between the crank 22 and the connecting element 2 it is possible to provide for the interposition of one or more mechanical bevel gears 25, 26 each configured to be connected to a suspended mass SM of the vehicle. In detail, a first bevel gear 25 is positioned between the connecting element 2 and the crank 22 and a second bevel gear 26 is positioned between the first bevel gear 25 and the connecting element 2.

According to a further embodiment, shown in the example of FIG. 4, the connecting element 2 may comprise a quadrilateral intended to be connected at one or more points to respective suspended masses SM of the vehicle.

According to several versions, the connecting element 2 of the device 1 may comprise metal bars or ropes and may be arranged along the entire perimeter of the vehicle or constrained to predefined points of suspended masses, such as e.g. doors, chassis, etc. In this context, the damping is advantageously distributed first vertically on the shock absorber elements 8 and subsequently on the plane of the chassis.

In a preferred embodiment, the device 1 of the invention comprises a connecting element 2 configured to be constrained at multiple constraint points V to a suspended mass SM of a vehicle and two adjustment elements 6, each positioned between the connecting element 2 and an unsuspended mass UM of the vehicle.

As has been appreciated, the active mechanical safety device for the compensation of the impacts on a vehicle according to the present invention enables the requirements to be met and the drawbacks referred to in the introductory part of the present description to be overcome with reference to the prior art.

Obviously, the embodiments and versions described and illustrated hereinabove are to be considered as purely illustrative, and an engineer in the art, in order to satisfy contingent and specific needs, may make numerous modifications and variations to the active mechanical safety device for the compensation of the impacts on a vehicle, all of which are however contained within the scope of protection of the invention, as defined by the following claims.

1) An active mechanical safety device for the compensation of the impacts on a vehicle, the active mechanical safety device comprising:
a connecting element configured to be constrained to a suspended mass of a vehicle, and
a respective adjustment element configured to be constrained to said suspended mass and to be positioned between said connecting element and a respective shock absorber element of said vehicle,
wherein said adjustment element, following an external stress to which said vehicle is subjected, is movable between a first position, wherein the adjustment element is configured to approach said connecting element to said shock absorber element, and a second position, wherein the adjustment element is configured to move said connecting element away from said shock absorber element.

2) The active mechanical safety device according to claim 1, further comprising: a piston that is capable of being coupled to said shock absorber element to slide therein, a plate of said piston being configured to be connected to said suspended mass and the shock absorber element being configured to be connected to a unsuspended mass of said vehicle.

3) The active mechanical safety device according to claim 2, wherein in said first position said plate is moved close to said shock absorber element, and wherein in said second position the plate of said piston is moved away from said shock absorber element.

4) The active mechanical safety device according to claim 2, wherein said shock absorber element extends between an upper end and a lower end, and wherein
said plate has at least one through hole for the transit of a corresponding tie rod extending between an upper extremity and a lower extremity, and
the lower extremity of said tie rod being connected to said upper end of said shock absorber element.

5) The active mechanical safety device according to claim 1, further comprising: a crank extended between a first termination and a second termination and configured to rotate around a constraint point positioned between said terminations, wherein the first termination is connected to the first terminal portion of said connecting element and the second termination is connected to the upper extremity of said tie rod.

6) The active mechanical safety device according to claim 1, wherein said connecting element comprises a bar or a rope.

7. The active mechanical safety device according to claim 1, wherein said shock absorber element is part of a suspension of said vehicle.

8. The active mechanical safety device according to claim 1, wherein said shock absorber element is part of a suspension of the MacPherson strut type.

9. A vehicle comprising:
a predetermined number of unsuspended masses,
at least one suspended mass,
at least one vehicle suspension system positioned between the unsuspended masses and said at least one suspended mass and comprising said at least one shock absorber element, and
at least one mechanical safety system according to claim 1 and operating in conjunction with said at least one shock absorber element.

10. A vehicle comprising:
a predetermined number of unsuspended masses,
a connecting element configured to be constrained to at least one suspended mass of said vehicle,
a respective adjustment element configured to be constrained to said at least one suspended mass and to be positioned between said connecting element and a respective shock absorber element of said vehicle,
wherein said adjustment element, following an external stress to which said vehicle is subjected, is movable between a first position, wherein the adjustment element is configured to approach said connecting element to said shock absorber element, and a second position, wherein the adjustment element is configured to move said connecting element away from said shock absorber element,
at least one vehicle suspension system positioned between the predetermined number of unsuspended masses and said at least one suspended mass and comprising said at least one shock absorber element, and
at least one mechanical safety system and operating in conjunction with said at least one shock absorber element.
